(19) United States
(12) Patent Application Publication
(10) Pub. No.: US 2019/0130296 A1
(43) Pub. Date: May 2, 2019

(54) POPULATING A USER INTERFACE USING QUADRATIC CONSTRAINTS

(71) Applicant: Microsoft Technology Licensing, LLC, Redmond, WA (US)

(72) Inventors: Kinjal Basu, Stanford, CA (US); Shaunak Chatterjee, Sunnyvale, CA (US); Ankan Saha, San Francisco, CA (US)

(21) Appl. No.: 15/794,872

(22) Filed: Oct. 26, 2017

(51) Int. Cl. G06N 7/00; G06F 9/44; G06F 7/544

(52) U.S. Cl. CPC G06N 7/005; G06F 7/544; G06F 9/4443

(57) ABSTRACT

A method may include determining a decision space representing a set of content items to be presented on a user interface of a social networking site, the decision space accounting for competing quadratic constraints and interaction effects, estimating the decision space to linearize the competing quadratic constraints, determining, in the estimated decision space and using an objective function, a display probability for each content item in the set of content items, each respective display probability corresponding to a given content item's probability of display in a specific content slot of a plurality of content slots on the user interface; and causing display of the content items with the highest display probabilities.

### TECHNICAL FIELD

The present application relates generally to the technical field of special-purpose machines that populate a user interface with items. More specifically, the present application regards using the special purpose machines to determine content to populate a user interface using a quadratic program approximation to a quadratically constrained quadratic program, such as can as by using a low discrepancy set.

### BACKGROUND

A social networking service is a computer- or web-based application that enables users to establish links or connections with persons for sharing information with one another. Some social networking services aim to enable friends and family to communicate with one another, while others are specifically directed to business users with a goal of enabling the sharing of business information. For purposes of the present disclosure, the terms “social network”, “social networking service”, “social networking system” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organization memberships, and so on. With some social networking services, a member's profile may be viewable to the public by default, or alternatively, the member may specify that only some portion of the profile is to be public by default. Accordingly, many social networking services serve as a sort of directory of people to be searched and browsed.

A social-networking system, such as that maintained by LinkedIn Corporation of Sunnyvale, Calif., United States of America, may have its success or usefulness measured at least in part by its ability to generate interest among its members (e.g., interesting postings in a news feed, potential job candidates, or the like) in a newsfeed, listings, or postings of available jobs posted on the social networking system. How much interest is generated among the members may depend on many factors, including, for example, the effectiveness of processes for providing content of interest to a user through a user interface.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment;

FIG. 2 is a block diagram showing functional components of a professional social network within a networked system, in accordance with an example embodiment;

FIG. 3 is a block diagram showing example components of a Content Optimization Engine, according to some embodiments.

FIG. 4 is a block diagram showing a data flow in a Content Optimization Engine, according to example embodiments;

FIG. 5 is a block diagram representing the operations and data structures of a user interface population Engine, according to example embodiments;

FIG. 6 is a diagram illustrating a selection of points of a low discrepancy set in two-dimensions, according to example embodiments;

FIG. 7 is a diagram illustrating a projection of a selected low discrepancy set from two-dimensions, to a sphere, to a higher-dimensional decision space, according to example embodiments;

FIG. 8 is a flowchart illustrating an example method, according to various embodiments;

FIG. 9 is a block diagram of an example computer system on which operations, actions and methodologies described herein may be executed, in accordance with an example embodiment.

### DETAILED DESCRIPTION

The present disclosure describes methods and systems for ranking content items to be displayed in a content feed in a professional social networking service (also referred to herein as a “professional social network,” “social network” or a “social network service”). Example methods and systems of enhancing usability and electronic resource efficiency are described. In the following description, for purposes of explanation, numerous specific details are set forth in order to provide a thorough understanding of example embodiments. It will be evident, however, to one skilled in the art that the present embodiments may be practiced without at least some of these specific details.

Consider a problem of determining which items to present to a user on a newsfeed (and what order to present the items). In some situations, such as where user-attention and revenue are not a concern. In such situations, determining which items to present to a user is trivial; any items will satisfy the non-existent constraints. However, in social networking systems, goals include retaining user attention, while still maintaining sufficient revenue. These goals are generally at odds with each other. A solution of items that maximizes revenue (presenting only advertisements) is not also a solution that maximizes user attention (presenting content of interest to the user that causes the user to spend more time on the social networking website). Thus, a balance is to be struck regarding user attention and revenue generation. Embodiments discussed herein can determine a solution of items to present to the user that strikes a balance between such competing interests.

Consider a problem of determining which items to present to a user in a people you may know page. It can be desirable to increase a number of connections between users of the social network site and increase a number of new users of the social network site. Thus, there can be competing constraints in presenting a list of people a user may know. Populating such a list can be accomplished using a technique discussed herein.

Other areas of social networking systems that include such lists and competing constraints include, by are not limited to, presenting a user with search results and notification updates. In presenting search results, ad revenue and user engagement can be competing constraints. In notification updates, user engagement and traffic to one of multiple sites can be competing constraints.

In example embodiments, various sub-systems of a social networking system are improved through a device or method that provides items to populate a user interface. The items can be chosen to improve user attention, increase revenue, increase traffic to a specified section of the social network, increasing users, increasing user connections, or other goals. The content items can be chosen in a manner that reduces an amount of time, compute resource bandwidth, power consumption, or compute resources required, such as to be more efficient than current techniques for populating a user interface.

In example embodiments, processing circuitry of a social networking system determines which items to use to populate a user interface. The processing circuitry can solve a quadratic program with quadratic constraints. The processing circuitry can perform the solving using one or more low discrepancy sequences to transform the quadratic constraints to linear constraints.

In general, the processing circuitry determines a decision space in which an objective may be minimized, based on the quadratic program and the quadratic constraints. A shape produced by connecting and filling between outermost points of the decision space can include an ellipsoid or other higher dimensional shape (e.g., more than three dimensions). The processing circuitry can choose a subset of the outermost points. The processing circuitry can estimate the shape of the decision space using respective planes through each of the chosen outermost points. A solution that minimizes an objective function can then be determined using the estimated shape space. The items of the solution can then be presented to a user, on a user interface (UI). The items of the solution can be presented in the order that minimizes the objective function.

A system, a machine-readable storage medium storing instructions, and a computer-implemented method are described herein are directed to a user interface population engine. The user interface population engine identifies a set of content items relevant to a target member account. Such relevance is determined according to a machine learning data model, one or more types of content features, and one or more types of member account features—as defined by the machine learning data model. The user interface population engine processes the set of content items according to a multi-objective (e.g., multi-constraint, such as can include one or more quadratic constraints) optimization technique to generate an ordered set of content items, where the ordered set of content items includes a diversity of content item types that meets a plurality of threshold requirements (e.g., constraints) that are in conflict with each other—such as satisfying a desired level of engagement of the target member account and also satisfying desired level of revenue generation, or other goal discussed herein.

According to various embodiments, the user interface population engine determines a display probability for each content item in a set of content items. Each respective display probability corresponds to a given content item's probability of display in a specific content slot of a plurality of content slots in a social network feed of a target member account of a social network service. The user interface population engine calculates a selection probability for each content item in an ordered set of the content items based on each display probability and a set of interaction effects. The ordered set of the content items assigns each content item to a specific content slot in the target member account's social network feed, such as to meet both a first target of expected social network activity (e.g., content selection, complaint) and a second target of expected revenue generation. The user interface population engine causes display of the ordered set of content items in the target member account's social network feed based on satisfaction of the first and second targets. It is understood that a “member account” in a social network service can also be referred to herein as a “user.”

A content slot is a portion of a user interface of a social network feed at which a content item can be displayed. Each member account has its own social network feed. A plurality of distinct content slots can be positioned throughout the social network feed. In some embodiments, a first content item is temporarily assigned to a particular content slot during a first social network session. During a subsequent second social network session, a second content item is temporarily assigned to the particular content slot.

Ranking content items to be recommended for display in a user's feed is a challenge in large scale social media applications. Various embodiments of the user interface population engine are described herein for determining a ranking of content items according to multi-objective optimization technique, such as to allow for the trade-off of multiple, potentially conflicting objectives against each other. Some current conventional systems optimize for a single content feed slot without considering the effect(s) of user interaction with other content items.

An interaction effect occurs when a probability of user interaction (such as content selection) with a first content item to be displayed at a content slot of the user's feed is modified based on a probability of a user's interaction with a second content item concurrently displayed at another content slot of the user's feed. If the first and second content items are of the same content type, then a likelihood that the user will access the first content item may be influenced by whether the user accesses the second content item before accessing the first content item—and vice versa. For example, where two content items are political news articles and both are scored as highly relevant to the user, displaying the two content items in the user's feed proximate to each other may result in the user favouring one content item over the other. This can be because the user may not be interested in reading two political news articles during the same social network session. As such, the content slot in the user's feed that is occupied by the ignored political news article can be better utilized by a content item of a different content item type or a sponsored content item that could generate revenue—even though the different content item and the sponsored content item may not be scored as being as relevant to the user as the content items providing access to the political news articles.

The user interface population engine identifies an ordered set of content items for all available content slots in a user's social network feed to optimize a display of a diversity of various types of content items. Such optimization is a constrained multi-slot-optimization solution based on competing requirements to generate a ranking of diverse types of content items likely to meet or exceed a desired user engagement level, where the ranking also includes one or more sponsored content items that are likely generate a target revenue.

The user interface population engine can identify a plurality of candidate content items, machine learning features of each candidate item, and machine learning feature of a target member account. The user interface population engine can determine a set of content items ranked according to their relevance to the target member account and the interaction effects amongst each other, such that display of the set of content items in the target member account's feed will prompt user engagement that satisfies a target engagement level. However, in addition, the ranked set of content items further includes one or more sponsored content items such that a target revenue goal can still be achieved.

It is understood that various embodiments described herein include encoded instructions that comprise operations to generate a user interface and various user interface elements. The user interface and the various user interface elements can be displayed to be representative of any of the member account features, the content item features, data models, content items, member accounts and content feed. In addition, the user interface and various user interface elements are generated by the user interface population engine for display on a computing device, a server computing device, a mobile computing device, etc.

It is understood that a machine learning data model is represented according to one more encoded instructions that, when executed, perform calculations that result in inferences, predictions, conclusions and estimations based in part on the training data. In one example, the machine learning data model can be a logistic regression model having one or more encoded instructions for feature vector assembly.

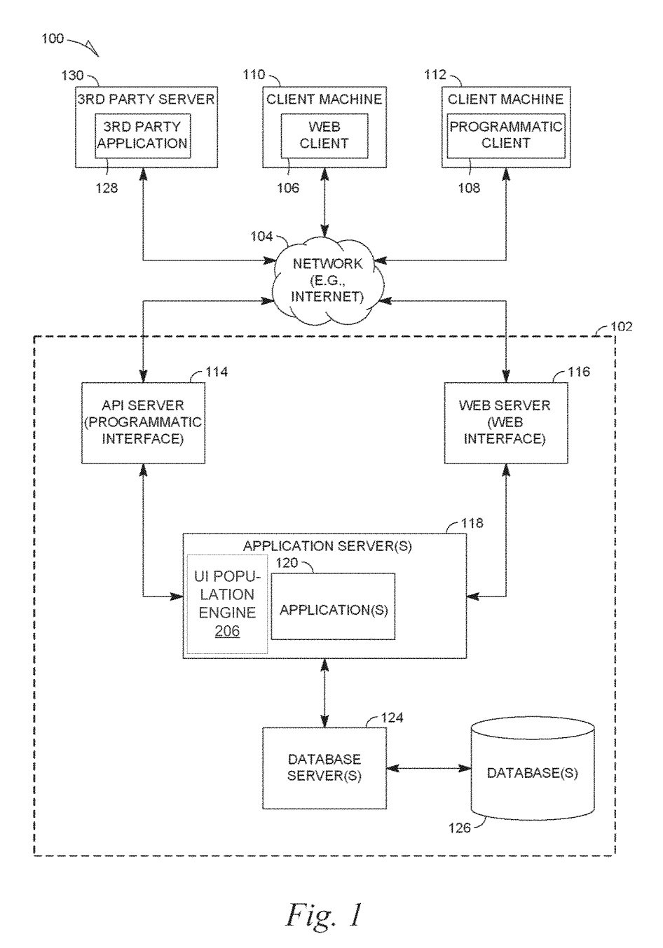

FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is not limited to such an architecture, and could be used in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third-party application 128, executing on a third-party server machine 130. The third-party server machine may have programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more functions that are supported by the relevant applications of the networked system 102. In some embodiments, the networked system 102 may comprise functional components of a professional social network.

The application servers 118 as illustrated host user interface (UI) population engine 206. The UI population engine 206 determines, among competing interests, which content items are to be used in populating a UI of the client machine 110 or 112. The content items may populate the UI of the client machine 110 or 112 in response to a user accessing a social networking site or selecting a control presented on the UI through the social networking site. For example, a user of the client machine 110 or 112 may select a notifications control that, when selected, causes the UI to present notification content items in a specified order. In another example, a user of the client machine 110 or 112 may log on to or select a control of a social networking site, and their newsfeed may be presented on a UI of the client machine 110 or 112 populated with newsfeed content items. The UI population engine 206 determines the content items (e.g., newsfeed content items, notification content items, or the like) that will be presented and the order in which the content items will be presented. More details regarding how the UI population engine 206 makes such determinations are provided elsewhere herein.

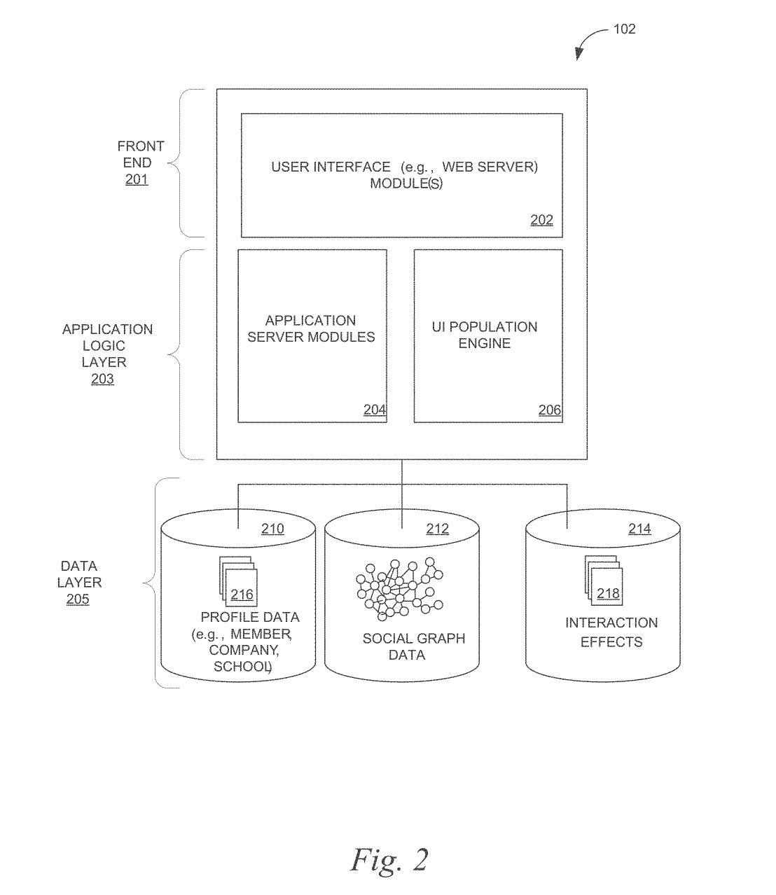

FIG. 2 is a block diagram showing functional components of a professional social network within the networked system 102, in accordance with an example embodiment. As shown in FIG. 2, the professional social network may include a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processing circuitry (e.g., a processor, field programmable gate array (FPGA), and/or components configured to execute instructions and perform operations dictated by the instructions, such as can include a transistor, resistor, inductor, capacitor, regulator, power source, multiplexer, amplifier, switch, buffer, diode, or the like) for executing the instructions. One skilled in the art recognizes that various additional functional modules and engines may be used with a professional social network, such as that illustrated in FIG. 2, to facilitate additional functionality that is not specifically described herein. The various functional modules and engines depicted in FIG. 2 may reside on a single server computer, or may be distributed across several server computers in various arrangements. Moreover, although a professional social network is depicted in FIG. 2 as a three-tiered architecture, embodiments are not limited to such architecture. Other architectures are within the scope of the present disclosure.

As shown in FIG. 2, in some embodiments, the front-end layer 201 comprises a user interface module (e.g., a web server) 202, which receives requests and inputs from various client-computing devices (e.g., client machine 110 or 112, or 3^{rd} party server 130), and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, or to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. In some embodiments, when a person initially registers to become a member of the professional social network, the person is prompted to provide some profile attribute data, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network, the representative may be prompted to provide certain information about the organization. This information may be stored, for example, in the database 210, or another database (not shown). In some embodiments, the profile data 216 may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or a seniority level within a company. In some embodiments, importing or otherwise accessing data from one or more externally hosted data sources may enhance profile data 216 for both members and organizations. For instance, with companies, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. The various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

In some embodiments, the professional social network provides an application programming interface (API) module through which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. Some third-party applications may reside and execute on one or more mobile devices (e.g., a smartphone, or tablet computing devices) having a mobile operating system, such as the client machine 110 or 112.

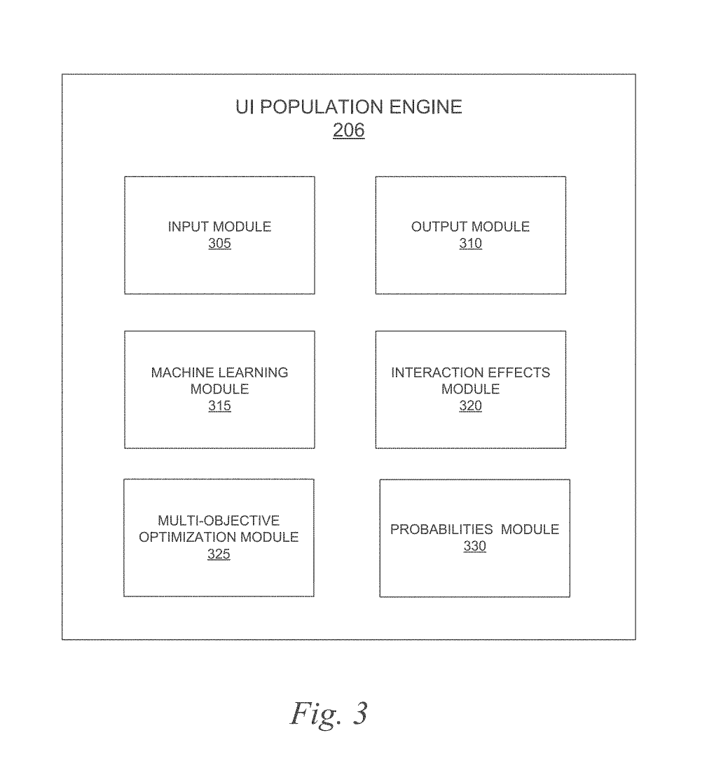

The data in the data layer 205 may be accessed, used, and adjusted by the UI population engine 206 as will be described in more detail below in conjunction with FIGS. 3-9. Although the UI population engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Although features of the present disclosure are referred to herein as being used or presented in the context of a web page, it is contemplated that any user interface view (e.g., a user interface on a mobile device or on desktop software) is within the scope of the present disclosure. In one embodiment, the data layer 205 further includes a database 214 that includes interaction effects 218 based on social network activity of one or more member accounts.

FIG. 3 is a block diagram showing example components of the UI population engine 206, according to some embodiments. The input module 305 is a hardware-implemented module that controls, manages and stores information related to any inputs from one or more components of system 102 as illustrated in FIG. 1 and FIG. 2. In various embodiments, the inputs include a plurality of content items, a target member account, training data, one or more historical interaction effects, or the like.

The output module 310 is a hardware-implemented module that controls, manages and stores information related to sending output data to one or more components of system 100 of FIG. 1 (e.g., one or more client devices 110, 112, third party server 130, etc.). In some embodiments, the output is an ordered set of content items that includes a diversity of content item types. Each content item in the ordered set of content items can be assigned a specific content slot in a social network feed of the target member account. The diversity of types of content items and the specific content slot assignments satisfy competing requirements. Satisfying the competing requirements can include estimating a constrained decision space represented by a quadratic program in a manner discussed in more detail elsewhere herein.

The machine learning module 315 is a hardware implemented module which manages, controls, stores, and accesses information related to building, training, updating and executing a machine learning data model. In some embodiments, a plurality of content items and the target member account can be input into the machine learning data model. The machine learning data model may return a set of content items determined by the machine learning data model to be relevant to the target member account. In some embodiments, the machine learning data model is a logistic regression model having one or more type of features with corresponding regression coefficients. The machine learning data model is built and refined according to training data, which may be based on historical social network activity data, historical member account data, or profile data of one or more member accounts.

The interaction effects module 320 is a hardware-implemented module which manages, controls, stores, and accesses information related to collecting interaction effects for a set of interaction effects. In some embodiments, the interaction effects module 320 collects member account behavior (such as content selection or complaint behavior) that results when a specific pair(s) of content items are concurrently displayed at various content feed slots. The interaction effects module 320 populates the interaction effects database 214.

The multi-objective optimization module 325 is a hardware-implemented module which manages, controls, stores, and accesses information related to executing a multi-objective optimization technique, such as may be used to determine which content items and an order in which to present the content items on a UI.

The probabilities module 330 is a hardware-implemented module which manages, controls, stores, and accesses information related to calculating content display probabilities and content selection probabilities. A content display probability represents a likelihood that a content item relevant to the target member account will be displayed at a specific content feed slot concurrently with display of other relevant content items assigned to other content feed slots A content selection probability represents a likelihood that a content item displayed at a specific content feed slot will be selected (e.g., clicked on, accessed, viewed, shared, commented, liked, or the like) by the target member account while one or more other content items are concurrently displayed at other content feed slots.

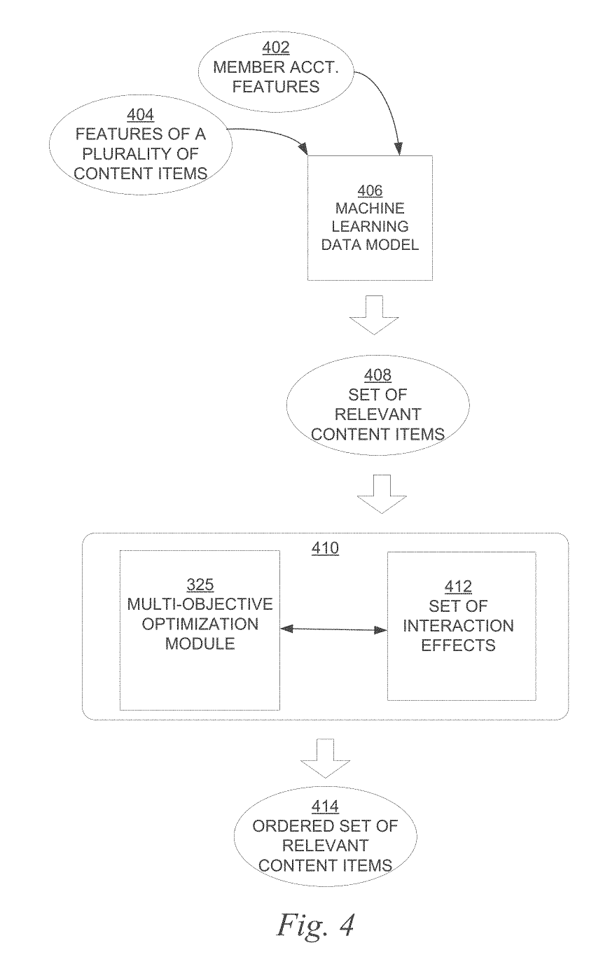

FIG. 4 is a block diagram showing a data flow in a UI population engine 206, according to an example embodiment. The UI population engine 206 applies a machine learning data model 406 on a plurality of content items to identify a set of relevant candidate content items 408 based on one or more type of content item features 404 present in the plurality of content items and one or more types of member account features 402 present in profile data of a target member account. The machine learning data model 406 has one or more learned content item features and one or more learned member account features. There is a plurality of types of content item features and a plurality of type of member account features.

In various embodiments, the machine learning data model can include a logistic regression model that has one or more encoded instructions for assembling feature vector data based on machine learning data model features and regression coefficients. The machine learning data model 406 determines a set of relevant content items 408 that includes one or more types of content items that are scored as being relevant to the target member account. In some embodiments, the set of relevant content items 408 can be a ranked list of most relevant content items, such that the first candidate content item is the most relevant content item, the second candidate content item is the second-most relevant content item, and the last candidate content item in the ranking is the least relevant content item from the set of relevant content items 408.

The UI population engine 206 operates on the set of relevant candidate content items 408 using an optimizer 410. The optimizer 410 includes a multi-objective optimization module 325 and a set of interaction effects 412. The optimizer 410 processes the set of relevant candidate content items 408 via the multi-objective optimization module 325 and the set of interaction effects to identify an ordered set of relevant content items 414. The ordered set of relevant content items 414 describes each content item to be displayed in a particular content slot of the target member account's social network content feed. The ordered set of relevant content items 414 includes a diversity of content item types that—when concurrently displayed in target member account's social network content feed—satisfies competing targets of a multi-objective optimization technique.

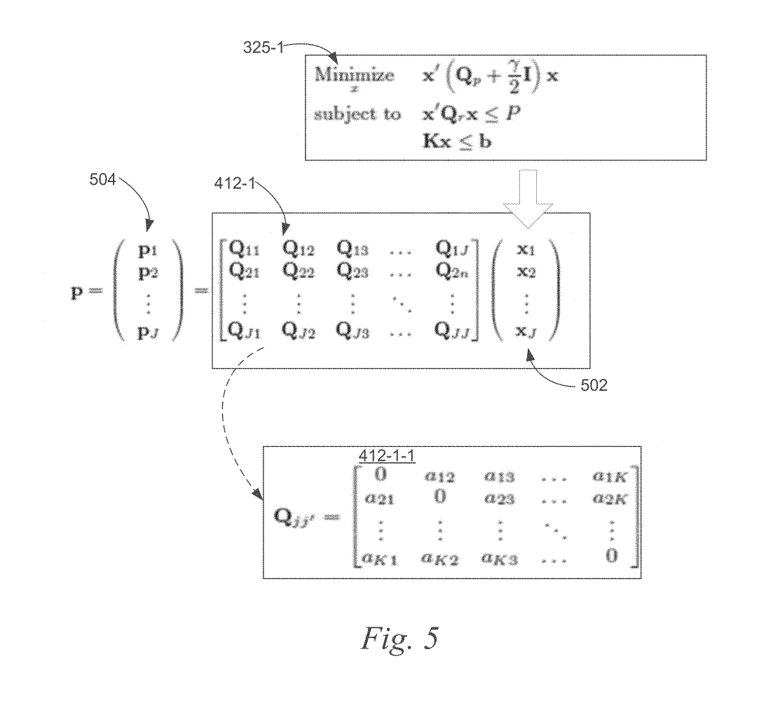

FIG. 5 is a block diagram representing the operations and data structure of a UI population engine 206, according to an example embodiment. The UI population engine 206 executes a multi-objective optimization technique 325-1 to determine which of the relevant candidate content items 408, 1-j, should be displayed—and in which content feed slot, 1-k. The UI population engine 206 calculates a probability (p) that a candidate content item will be clicked on or otherwise selected by a user. Such a probability (p) for each candidate content item accounts for interaction effects of other candidate content items that may be concurrently displayed in the target member account's content feed.

The UI population engine 206 represents a vector (p) of vectors 504 of content item selection probabilities. That is, for the set of candidate items 408, 1-j, p₁ itself represents a vector of size k, p₂ represents a vector of size k and pⱼ represents a vector of size k. Vector p₁ has vector units p₁₁, p₁₂ . . . p₁ₖ. Vector p₂ has vector units p₂₁, p₂₂ . . . p₂ₖ. Vector pⱼ has vector units pⱼ₁, pⱼ₂ . . . pⱼₖ. For example, vector p₁, corresponds to a first candidate content item (such as a news article) to be selected when assigned to the different content slots. It follows then, that a vector unit (p₁₁) represents a probability that the first candidate content item will be selected if displayed at the first content feed slot. Further, a vector unit (p₁₂) represents a probability that the first candidate content item will be selected if displayed at the second feed slot. Similarly, a vector unit (p₁ₖ) represents a probability that the first candidate content item will be selected if displayed at the k-th feed slot. For a second candidate content item, such as a sponsored content item, the corresponding vector is p₂. It follows then, that a vector unit (p₂₁) represents a probability that the second candidate content item will be selected if displayed at the first content feed slot. Similarly, a vector unit (p₂ₖ) represents a probability that the second candidate content item will be selected if displayed at the k-th feed slot. The UI population engine 206 selects from the vector (p) of vectors 504 a select vector that represents an ordered set of candidate items that best satisfies the competing requirements of the multi-objective optimization.

The UI population engine 206 operates using a vector (x) of vectors 502 of content item display probabilities. For the set of candidate items 408, 1-j, x₁ represents a vector of size k, x₂ represents a vector of size k, and xⱼ represents a vector of size k. Vector x₁ has vector units x₁₁, x₁₂, x₁ₖ. Vector x₂ has vector units x₂₁, x₂₂ . . . x₂ₖ. Vector xⱼ has vector units xⱼ₁, xⱼ₂ . . . xⱼₖ. A vector unit (x₁₁) in vector x₁ represents a probability of displaying the first candidate content item at the first content feed slot. A vector unit (x₁₂) in vector x₁ represents a probability of displaying the first candidate content item at the second content feed slot, and a vector unit (x₁ₖ) represents a probability of displaying the first candidate content item at the k-th content feed slot. Similarly, a vector unit (x₂₁) in vector x₂ represents a probability of displaying the second candidate content item at the first content feed slot. A vector unit (x₂₂) in vector x₂ represents a probability of displaying the second candidate content item at the second content feed slot, and a vector unit (x₂ₖ) represents a probability of displaying the second candidate content item at the k-th content feed slot.

The UI population engine 206 generates the vector (x) of vectors 502 according to the multi-objective optimization technique 325-1, such as can be executed by the multi-objective optimization module 325. The matrix Qₚ represents the matrix of matrices 412-1 which corresponds to the interaction factors of clicks on different items spread across different slots. The factor γ is a normalizing weight associated with the objective function of the multi-objective optimization technique 325-1. The matrix I is an identity matrix having a value “1” in all entries on a diagonal of the matrix and “0” everywhere else. The matrix Qᵣ represents the matrix of matrices similar to 412-1 which corresponds to the interaction factors of complaints on different items spread across different slots. P represents a scalar threshold of the complaints. The matrix K formulates a set of linear constraints, based on quadratic constraints, that the display probability must hold. Finally, b represents the thresholds on the linear constraints on the display probability (x).

The UI population engine 206 further represents a matrix of matrices 412-1 in the set of interaction effects 412. Each individual matrix Q₁₁, Q₁₂, Q₁₃ . . . Qⱼⱼ models the interaction effects between a pair of content items when the content items are concurrently displayed at a pair of content slots in the same social network content feed. That is, each matrix based on example matrix Q_{jj′} 412-1-1 as including a plurality of different values (a) of interaction effects for candidate content items j and j′ when concurrently displayed at a pair of content feed slots from content slot 1-k. For example, matrix Q₁₂ represents the interaction effects between the 1^{st} candidate content item and the 2^{nd} candidate content item when concurrently displayed at various content feed slots. For example, in matrix Q₁₂, a₁₂ relates to the first and second content feed slots. Specifically, a₁₂ of matrix Q₁₂ is a pre-calculated value representing an interaction effect between the 1^{st} and 2^{nd} candidate content items when the 1^{st} candidate content item is displayed in the 1^{st} contend feed slot while the 2^{nd} candidate content item is displayed in the 2^{nd} content feed slot. In matrix Q₁₂, a₂₃ is a pre-calculated value representing an interaction effect between the 1^{st} and 2^{nd} candidate content items when the 1^{st} candidate content item is displayed in the 2^{nd} contend feed slot and the 2^{nd} candidate content item is displayed in the 3^{rd} content feed slot. Further, in matrix Q₁₂, aₖ₃ is a pre-calculated value representing an interaction effect between the 1^{st} and 2^{nd} candidate content items when the 1^{st} candidate content item is displayed in the K-th content feed slot and the 2^{nd} candidate content item is displayed in the 3^{rd} content feed slot.

It follows, then, that matrix Q₁₃ models interaction effects between the 1^{st} and 3^{rd} candidate content items. The pre-defined value of a₂₃ in matrix Q₁₃ represents an interaction effect between the 1^{st} and 3^{rd} candidate content items when the 1^{st} candidate content item is displayed in the 2^{nd} contend feed slot and the 3^{rd} candidate content item is displayed in the 3^{rd} content feed slot. Matrix Qⱼ₃ thus represents the interaction effects between the j-th candidate content item and the 3^{rd} candidate content item. Therefore, for Qⱼ₃, a₁₂ represents the interaction effect that will occur when the j-th candidate content item is displayed at the first content feed slot and the third candidate content item displayed at the second content feed slot.

It is noted that a₂₃ for interaction effects between the 2^{nd} and 3^{rd} content feed slots may have a different value in matrix Q₁₂ than in matrix Q₂₁—since each interaction effect value for a is specific to a matrix' pairing of particular candidate content items j and j′. An interaction effect can be a selecting interaction effect that is a numerical value that represents a likelihood that a content item will be selected, when it is presented in a particular content feed slot, while another content item is presented in some other content feed slot. Each selecting interaction effect for a pair of content feed slots is based on historical member account select data from a plurality of member accounts. The historical member account select data indicates how many member accounts previously selected by one of the paired content items when displayed at specific content feed slots. An interaction effect can be a complaint interaction effect that represents a likelihood that a member account will send a complaint response when a content item is presented in the particular content feed slot while another content item is presented in another content feed slot. As such, each complaint interaction effect for a pair of content items positioned in a specific pair of content feed slots is based on historical member account complaint data from the plurality of member accounts. The historical member account complaint data indicates how many target member accounts initiated complaint behaviours in response to the pair of items being displayed at specific content feed slots.

What follows is a description of how the UI population engine 206, such as the multi-objective optimization module 325, determines which content items to present to the user, and the order in which to present the items. The determination of which content items to present includes multiple competing interests, such as gaining user attention, generating revenue, or the like. Determining what content items to present, based on these competing interests (sometimes called constraints or goals) falls within a class of problems called quadratically constrained quadratic programs (QCQP). Such problems occur naturally in many scientific and web applications. Although there are some methods that solve QCQP problems, the solutions are mostly not scalable. Embodiments transform the quadratic constraint into a linear form by sampling a set of low-discrepancy points and transforming a space of possible outcomes. The transformed problem can then be solved by applying a large-scale quadratic programming solver. The convergence of the approximate solution to the true solution is provided along with some finite sample error bounds in a section titled “Additional Material”. Experimental results are also shown in the “Additional Material” section, such as to help show scalability, as well as improved quality of the approximation in practice.

A QCQP may be summarized as follows:

$${Minimize}_{x} \frac{1}{2} {x}^{T} {P}_{0} x + {q}_{0}^{T} x + {r}_{0} \\ subject to \frac{1}{2} {x}^{T} {P}_{i} x + {q}_{i}^{T} x + {r}_{i} \leq 0 , i = 1 , … , m \\ Ax = b , \qquad ( 1 )$$

Where P₀, . . . , Pₘ are n×n matrices. If each of these matrices are positive definite, then the optimization problem is convex. In general, however, solving QCQP is NP-hard, which can be verified by reducing a 0-1 integer programming problem (known to be NP-hard) to a QCQP. Despite that challenge, QCQPs form an important class of optimization problems, since QCQPs arise naturally in many engineering, scientific and web applications. Two famous examples of QCQP include the max-cut and Boolean optimization. Other examples include alignment of kernels in semi-supervised learning, learning the kernel matrix in discriminant analysis, more general learning of kernel matrices, steering direction estimation for radar detection, several applications in signal processing, the triangulation in computer vision, among others.

Internet applications, handling large scale of data, often model trade-offs between key utilities using constrained optimization formulations. When there is independence among the expected utilities (e.g., click, impression, time spent, revenue obtained) of items, the objective or the constraints corresponding to those utilities are linear. However, in most real scenarios, there is dependence among expected utilities of items presented together on a web page or mobile app. Examples of such dependence are abundant in newsfeeds, search result pages, notification presentation, jobs you might be interested in, or the like. If this dependence is expressed through a linear model, it makes the corresponding objective and/or constraint quadratic. This makes the constrained optimization problem a very large scale QCQP, if the dependence matrix (often enumerated by a very large number of members or updates) is positive definite.

Although there is a plethora of such applications, solving this problem on a large scale is still challenging. There are two main relaxation techniques that are used to solve a QCQP, namely, semi-definite programming (SDP) and reformulation-linearization technique (RLT). However, both introduce a new variable X=xx^{T} so that the problem becomes linear in X. Then the condition X=xx^{T} is relaxed by different means. Doing so unfortunately increases the number of variables from n to O(n²). This makes these methods prohibitively expensive for most largescale applications. There is literature comparing these methods which also provides certain combinations and generalizations. However, the methods all suffer from the same problem of dealing with O(n²) variables. Even when the problem is convex, there are techniques such as second order cone programming, which can be efficient, but scalability remains an important issue with prior QCQP solvers.

Embodiments introduce a novel approximate solution to the convex QCQP which can be used in such large-scale situations. Embodiments approximate the quadratic constraints by a set of linear constraints, thus converting the problem into a quadratic program (QP). In doing so, the problem still has n variables instead of O(n²). A QP solver, such as Operator Splitting or alternating direction method of multipliers (ADMM), which are well adapted for distributed computing, may be used to determine the final solution for problems of much larger scale.

The description of embodiments of reducing the QCQP to a QP process with a description of the approximate problem, concepts to understand the sampling scheme, the approximation technique to convert the problem into a QP. The “Additional Material” section includes the proof of convergence, and the experimental results.

For sake of simplicity throughout the paper, a QCQP having a single quadratic constraint is considered. The procedure detailed can be generalized to multiple constraints. Without loss of generality the problem is of the form,

$${Minimize}_{x} {( x - a )}^{T} A ( x - a ) \\ subject to {( x - b )}^{T} B ( x - b ) \leq \tilde{b} , \\ Cx = c . \qquad ( 2 )$$

This is a special case of the general formulation in (1). The discussion is restricted to A and B being positive definite matrices so that the objective function is strongly convex.

The linearization technique to convert the quadratic constraint into a set of N linear constraints is provided. Given any convex set in the Euclidean plane, there exists a convex polytope that covers the set.

Let P denote the optimization problem (2). Define,

S:={x∈Rⁿ:(x−b)^{T}B(x−b)≤\tilde{b}}. (3)

Let ∂S denote the boundary of the ellipsoid S. To generate the N linear constraints for this one quadratic constraint, a set of N points is generated, X_{N}={x₁, . . . , x_{N}} such that each xⱼ∈∂S for j=1, . . . , N. The sampling technique to select the point set is given elsewhere herein. The following set of N linear constraints corresponding to these N points are:

(x−b)^{T}B(xⱼ−b)≤\tilde{b} for j=1, . . . ,N. (4)

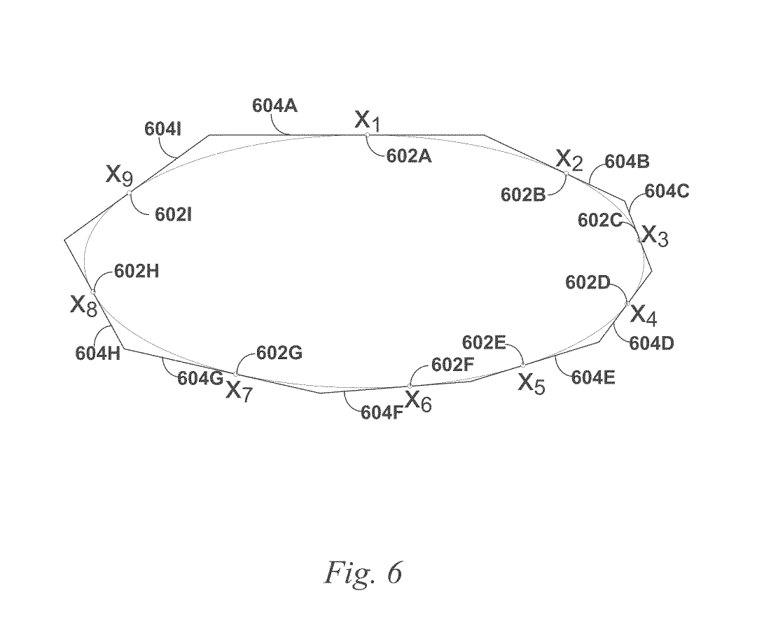

Looking at it geometrically, each of these linear constraints are tangent planes to S at xj for j=1, . . . , N. FIG. 6 shows a set of 9 linear constraints for an ellipsoidal feasible set in two dimensions. Tangent planes 604A, 604B, 604C, 604D, 604E, 604F, 604G, 604H, and 604I, through the 9 points x₁, . . . , x₉ create the approximation to S. Each of the points 602A, 602B, 602C, 602D, 602E, 602F, 602G, 602H, and 602I are used to define a respective plane 604A-604I tangent to the ellipse. An area within an intersection of the planes 604A-604I may be used to estimate the ellipse, linearizing the quadratic constraint.

Using these N linear constraints the approximate optimization problem P(X_{N}), can be written as follows.

$${Minimize}_{x} {( x - a )}^{T} A ( x - a ) \\ subject to {( x - b )}^{T} B ( {x}_{j} - b ) \leq \tilde{b} for j = 1 , … , N \\ Cx = c . \qquad ( 5 )$$

Instead of solving P, P(X_{N}) is solved for a large enough value of N. As more points are sample, the approximation keeps getting better. The accuracy of the solution of P(X_{N}) depends on the choice of X_{N}. The tangent planes to S at those N points create a cover of S. A bounded cover can be defined as follows.

Definition 1. Let T be the convex polytope generated by the tangent planes to S at the points X₁, . . . , X_{N}∈∂S. T is said to be a bounded cover of S if

$$d ( T , S ) := {sup}_{t ∈ T} d ( t , S ) < ∞$$

where d(t,S):=inf_{x∈S}∥t−x∥ and ∥·∥ denotes a Euclidean distance.

A first results shows that there exists a bounded cover with only n+1 points.

Lemma 1. Let S be an n dimensional ellipsoid as defined in (3). Then there exists a bounded cover with n+1 points.

Proof. Note that since S is a compact convex body in Rⁿ(n-dimensional space of real numbers) there exists a shifted copy of an n-dimensional simplex T={x∈R₊ⁿ: Σᵢ₌₁ⁿxᵢ≤K} such that S⊆T.

T can be reduced such that each edge touches S tangentially. Since there are n+1 faces, tangent surfaces of n+1 may create the bounded cover.

Although Lemma 1 gives a simple constructive proof of a bounded cover, it is desired to construct a bounded cover T which is as close as possible to S, thus leading to a better approximation. Formally, an optimal bounded cover is defined.

Definition 2. T*=T(x₁*, . . . , x_{N}*) is said to be an optimal bounded cover, if

$${sup}_{t ∈ {T}^{*}} d ( t , S ) \leq {sup}_{t ∈ T} d ( t , S )$$

for any bounded cover T generated by any other N-point sets. Moreover, {x₁*, . . . , x_{N}*} are defined to be the optimal N-point set. Note that the optimal N-point set can be a set of N points that minimize the maximum distance between T and S, such that

$${T}^{*} = {arg min}_{T} d ( T , S ) .$$

The optimal N-point set on the unit circle in two dimensions are the N-th roots of unity, unique up to rotation. The N-th roots of unity minimize the discrete Riesz energy for the unit circle. The concept of Riesz energy also exists in higher dimensions. Thus, generalizing this result, an optimal N-point set on ∂S is chosen which tries to minimize the Riesz energy. Minimizing Riesz energy is described.

Riesz energy of a point set A_{N}={x₁, . . . , x_{N}} is defined as Eₛ(A_{N}):=Σ_{i≠j=1}^{N}∥xᵢ−xⱼ∥^{-s} “good” configuration of points. The measures associated to the optimal point set that minimizes the Riesz energy on OS converge to the normalized surface measure of ∂S, where normalized surface measure σₙ is defined as a probability on the n-sphere Sⁿ, with σₙ(Sⁿ)=1. Using this fact, the optimal N-point set is associated to the set of N points that minimize the Riesz energy on ∂S. To describe these good configurations of points, the concept of equidistribution is provided. A “good” or equidistributed point set in the unit hypercube is chosen and mapped to ∂S such that the equidistribution property still holds.

Informally, a set of points in the unit hypercube is said to be equidistributed if the expected number of points inside any axis-parallel subregion, matches the true number of points. One such point set in [0, 1]ⁿ is called the (t, m, n)-net in base η. It is a set of N=η^{m} points in [0, 1]ⁿ such that any axis parallel η-adic box with volume η^{t-m} would contain exactly η^{t} points. Formally, it is a point set that can attain the optimal integration error of O((log(N))ⁿ⁻¹/N and is usually referred to as a low-discrepancy point set.

The point set on [0, 1]ⁿ can be mapped to ∂s using a measure preserving transformation so that the equidistribution property remains intact. The mapping is described in two steps. First, the point set from [0, 1]ⁿ is mapped to the hyper-sphere Sⁿ={x∈Rⁿ⁺¹: x^{T}x=1}). Then the hypersphere is mapped to ∂S.

The cylindrical coordinates of the n-sphere, can be represented as

$$\begin{matrix}x = {x}_{n} = ( \sqrt{1 - {t}_{n}^{2}} {x}_{n - 1} , {t}_{n} ) , … , {x}_{2} \\ = ( \sqrt{1 - {t}_{2}^{2}} {x}_{1} , {t}_{2} ) , {x}_{1} = ( cos φ , sin φ )\end{matrix}$$

Where 0≤ϕ≤2π, −1≤t_{d}≤1, x_{d} ∈S^{d} and d=(1, . . . , n). Thus, an arbitrary point x∈Sⁿ can be represented through angle ϕ and heights t₂, . . . , tₙ as, X=X(ϕ, t₂, . . . , tₙ),

0≤ϕ≤2π,−1≤t₂, . . . ,tₙ≤1

A point is mapped as y=(y₁, . . . , yₙ)∈(0,1)ⁿ to x∈Sⁿ using

φ₁(y₁)=2πy₁,φ_{d}(y_{d})=1−2y_{d}(d=2, . . . ,n)

and cylindrical coordinates

x=Φₙ(y)=x(φ₁(y₁),φ₂(y₂), . . . ,φₙ(yₙ)).

Instead of using (t, m, n)-nets and mapping to Sⁿ, spherical t-designs can be used. Construction of such sets still requires lots of computation in high dimensions.

Consider the map ψ to translate the point set from Sⁿ⁻¹ to ∂S.

ψ(x)=\sqrt{\tilde{b}}B^{-1/2}x+b (6)

From the definition of S in (3), it follows that ψ(x)∈∂S. The next result shows that this also an area-preserving map, in the sense of normalized surface measures.

Lemma 2. Let ψ be a mapping from Sⁿ⁻¹→∂S as defined in (6). Then for any set A⊆∂S,

σₙ(A)=λₙ(ψ⁻¹(A))

where, σₙ, λₙ are the normalized surface measure of ∂S and Sⁿ⁻¹ respectively.

Proof. Pick any A⊆∂S. Then,

$${ψ}^{- 1} ( A ) = \{ \frac{1}{\sqrt{\tilde{b}}} {B}^{1 / 2} ( x - b ) : x ∈ A \} .$$

Since the linear shift does not change the surface area,

$${λ}_{n} ( {ψ}^{- 1} ( A ) ) = {λ}_{n} ( \{ \frac{1}{\sqrt{\tilde{b}}} {B}^{1 / 2} ( x - b ) : x ∈ A \} ) = {λ}_{n} ( \{ \frac{1}{\sqrt{\tilde{b}}} {B}^{1 / 2} x : x ∈ A \} ) = {σ}_{n} ( A )$$

where the last equality follows from the definition of normalized surface measures. This completes the proof.

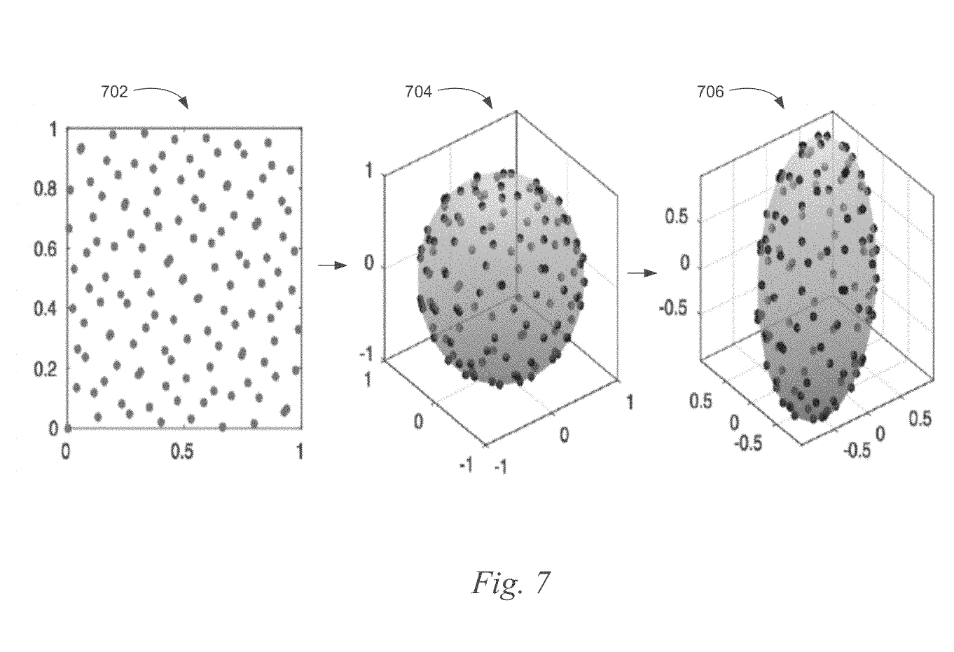

Using Lemma 2, the map ψºΦₙ₋₁:[0, 1)ⁿ⁻¹→∂S, is a measure preserving map. Using this map and the (t, m, n−1) net in base η, the optimal η^{m}-point set on ∂S can be derived. FIG. 7 shows how a transform of a (0, 7, 2)-net in base 2 to a sphere and then to an ellipsoid. In FIG. 7, a left panel 702 shows a (0, 7, 2)-net in base 2 that is mapped to a sphere in 3 dimensions (middle panel 704) and then mapped to the ellipsoid as seen in the right panel 706.

Pseudocode of the approximation technique to linearize the QCQP is provided below. The approximation of P by P(X_{N}) uses a set of points x₁, . . . , x_{N} as described previously and below. After approximation of P as P(X_{N}), the large scale QP. P(X_{N}) can be solved using a solver, such as Operator Splitting or Block Splitting approaches.

Pseudocode for Point Simulation on ∂S

1: Input : B, b, \tilde{b} to specify S and N = η^{m} points
2: Output : x₁,..., x_{N} ∈ ∂S
3: Generate y₁,...,y_{N} as a (t, m, n−1)-net in base η.
4: for i ∈ 1,..., N do
5: xᵢ = ψ^{o}Φₙ₋₁ (yᵢ)
6: end for
7: return x₁,...,x_{N}

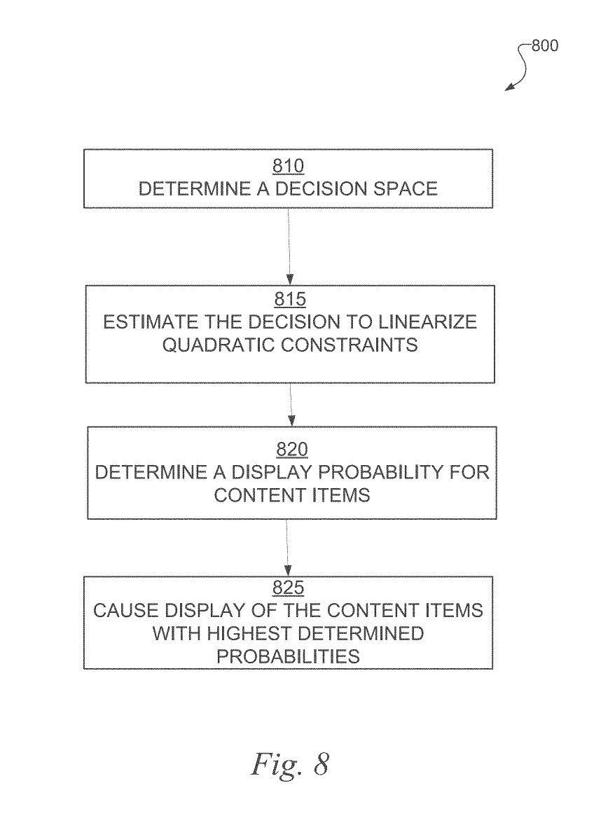

FIG. 8 is a flowchart illustrating an example method 800, according to various embodiments. At operation 810, the UI population engine 206 determines a decision space representing a set of content items to be presented on a user interface of a social networking site, the decision space accounting for competing quadratic constraints and interaction effects. The competing constraints can be dependent on one another, to make them quadratic. The decision space is discussed regarding at least FIGS. 4-7 and can include content items, interaction effects, probabilities, or the like. The decision space is sometimes referred to as ∂S.

At operation 815, the UI population engine 206 estimates the decision space to linearize the competing quadratic constraints. The operation 815 can include selecting points on an outer surface of the decision space. Selecting the points on the outer surface of the decision space can include selecting points that minimize Riesz energy. The operation 815 can include mapping the selected points to a hypersphere and then mapping the points mapped to the hypersphere to the decision space. The operation 815 can include determining a linear bounded cover of planes tangent to the decision space to create the estimated decision space, each of the planes tangent to the decision space including a point of the selected points mapped to the decision space. The selected points may be equidistributed.

At operation 820, the UI population engine 206 determines, in the estimated decision space and using an objective function, a display probability for each content item in the set of content items, each respective display probability corresponding to a given content item's probability of display in a specific content slot of a plurality of content slots on the user interface.

At operation 825, the UI population engine 206 causes display of the content items with the highest display probabilities.

The method 800 can further include generating the set of interaction effects, each interaction effect defined for a specific pair of content items concurrently displayed at a specific pair of content slots in a social network feed, each interaction effect representative of social network activity that occurred due to display of a corresponding pair of content items to various member accounts.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module mechanically, in dedicated and permanently configured circuitry, or in temporarily configured circuitry (e.g., configured by software) may be driven by cost and time considerations.

The term “hardware module” is a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. Another hardware module may, at a later time, access the memory device to retrieve and process the stored output. Hardware modules may initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product (e.g., a computer program tangibly embodied in an information carrier, such as in a machine-readable medium for execution by, or to control the operation of, data processing apparatus, such as a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server is generally remote from each other and typically interact through a communication network. The relationship of client and server arises through computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

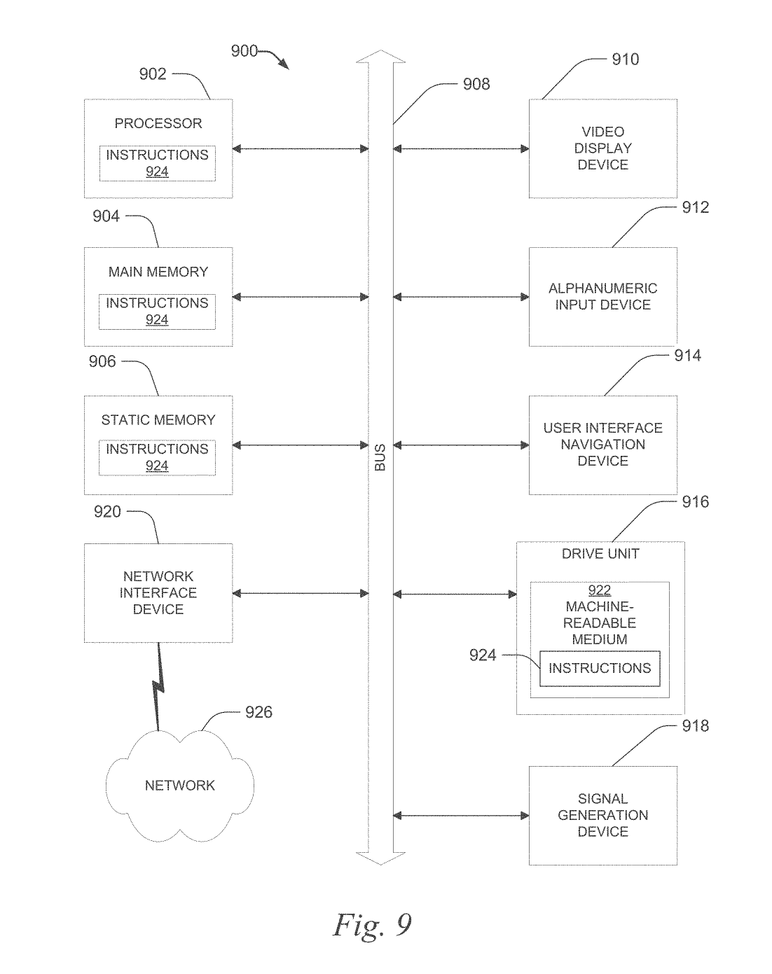

FIG. 9 is a block diagram of an example computer system 900 on which operations, actions and methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 900 includes a processor 902 (e.g., a central processing unit (CPU), a graphics processing unit (GPU) or both), a main memory 904, and a static memory 906, which communicate with each other via a bus 908. Computer system 900 may further include a video display device 910 (e.g., a liquid crystal display (LCD) or a cathode ray tube (CRT)). Computer system 900 also includes an alphanumeric input device 912 (e.g., a keyboard), a user interface (UI) navigation device 914 (e.g., a mouse or touch sensitive display), a disk drive unit 916, a signal generation device 918 (e.g., a speaker) and a network interface device 920.

Disk drive unit 916 includes a machine-readable medium 922 on which is stored one or more sets of instructions and data structures (e.g., software) 924 embodying or utilized by any one or more of the methodologies or functions described herein. Instructions 924 may also reside, completely or at least partially, within main memory 904, within static memory 906, and/or within processor 902 during execution thereof by computer system 900, main memory 904 and processor 902 also constituting machine-readable media.

While machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” includes any tangible medium that may store, encode, or carry instructions for execution by the machine and that cause the machine to perform any one or more of the methodologies of the present technology, or that may store, encode, or carry data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., erasable programmable read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 924 may further be transmitted or received over a communications network 926 using a transmission medium. Instructions 924 may be transmitted using network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that may store, encode, or carry instructions for execution by the machine, and includes digital or analog communications signals or other intangible media to facilitate communication of such software.

Additional Material

Convergence of P(XN) to P

In this section, it is shown that P(X_{N}), converges to the original problem P as N→∞. Some finite sample results are provided to give error bounds on the solution to P(X_{N}).

Let x*, x*(N) denote the solution to P and P(X_{N}) respectively and ƒ(·) denote the strongly convex objective function in (2), i.e., for ease of notation

ƒ(x)=(x−a)^{T}A(x−a).

Theorem 1. Let P be the QCQP defined in (2) and P(X_{N}) be the approximate QP problem defined in (5) via Algorithm 1. Then, P(X_{N})→P as N→∞ in the sense that

lim_{N→∞}∥x*(N)−x*∥=0.

Proof. Fix any N. Let T_{N} denote the optimal bounded cover constructed with N points on ∂S. Note that to prove the result, it is enough to show that T_{N}→S as N→∞. This guarantees that linear constraints of P(X_{N}) converge to the quadratic constraint of P, and hence the two problems match.

Now since S⊆T_{N} for all N, S⊆lim_{N→∞}T_{N}.

To prove the converse, let t₀ ∈lim_{N→∞}T_{N} but t₀∉S. Thus, d(t₀,S)>0. Let t₁ denote the projection of t₀ onto S. Thus, t₀≠t₁ ∈∂S. Choose ∈ to arbitrarily small and consider any region A_{∈} around t₁ on ∂S such that d(x, t₁)≤∈ for all x∈A_{∈}. Here d denotes the surface distance function. By the equidistribution property of Algorithm 1 as N→∞, there exists a point t*∈A_{∈}, the tangent plane through which cuts the plane joining t₀ and t₁. Thus, lim_{N→∞}T_{N}. Hence, a contradiction and the result is proved.

As a Corollary to Theorem 1

lim_{N→∞}|ƒ(x*(N))−ƒ(x*)|=0.

Some finite sample results are now provided.
Theorem 2. Let g: N→R such that lim_{n→∞}g(n)=0. Further assume that ∥x*(N)−x*∥≤C₁ g(N) for some constant C₁>0. Then, |ƒ(x*(N))−ƒ(x*)|≤C₂g(N) where C₂>0 is a constant.
Proof. Begin by bounding the ∥x*∥. Since x*satisfies the constraint of the optimization problem, resulting in,

\tilde{b}≥(x*−b)^{T}B(x*−b)≥σₘᵢₙ(B)∥x*−b∥²,

where σₘᵢₙ(B) denotes the smallest singular value of X. Thus,

$$‖ {x}^{*} ‖ \leq ‖ b ‖ + \sqrt{\frac{\tilde{b}}{{σ}_{min} ( B )}}$$

Since ƒ(x)=(x−a)^{T} A(x−a) and ∇ƒ(x)=2A(x−a),

$$\begin{matrix}f ( x ) = f ( {x}^{*} ) + {\int }_{0}^{1} 〈 ∇ f ( {x}^{*} + t ( x - {x}^{*} ) ) , x - {x}^{*} 〉 dt \\ = f ( {x}^{*} ) + 〈 ∇ f ( {x}^{*} ) , x - {x}^{*} 〉 + \\ {\int }_{0}^{1} 〈 ∇ f ( {x}^{*} + t ( x - {x}^{*} ) ) - ∇ f ( {x}^{*} ) , x - {x}^{*} 〉 dt \\ = {I}_{1} + {I}_{2} + {I}_{3} ( say ) .\end{matrix}$$

The last term can be bounded as follows. Using Cauchy-Schwarz inequality,

|I₃|≤∫₀¹| [symbol] ∇ƒ(x*+t(x−x*))−∇ƒ(x*),x−x* [symbol] |dt

≤∫₀¹∥∇ƒ(x*+t(x−x*))−∇ƒ(x*)∥∥x−x*∥dt

≤2σₘₐₓ(A)∫₀¹∥t(x−x*∥∥x−x*∥dt=σₘₐₓ(A)∥x−x*∥²,

where σₘₐₓ (A) denotes the largest singular value of A. Thus,

ƒ(x)=ƒ(x*)+ [symbol] ∇ƒ(x*),x−x* [symbol] +\tilde{C}∥x−x*∥² (8)

where |\tilde{C}|≤σₘₐₓ (A). Furthermore,

$$\vert 〈 ∇ f ( {x}^{*} ) , {x}^{*} ( N ) - {x}^{*} 〉 \vert = \vert 〈 2 A ( {x}^{*} - a ) , {x}^{*} ( N ) - {x}^{*} 〉 \vert \leq 2 {σ}_{max} ( A ) ( ‖ {x}^{*} ‖ + ‖ a ‖ ) ‖ {x}^{*} ( N ) - {x}^{*} ‖ \leq 2 {C}_{1} {σ}_{max} ( A ) ( \sqrt{\frac{\tilde{b}}{{σ}_{min} ( B )} + ‖ b ‖ + ‖ a ‖} ) g ( N ) \qquad ( 9 )$$

where the last line inequality follows from (7). Combining (8) and (9) the result follows.

Note that the function g gives an idea about how fast x*(N) converges x*. To help, identify the function, g, state the following results.

Lemma 3. If ƒ(x*)=ƒ(x*(N)), then x*=x*(N). Furthermore, if ƒ(x*)≥ƒ(x*(N)), then x*∈∂U and x*(N)∉U, where U=S∩{x: Cx=c} is the feasible set for (2).

Proof. Let V=T_{N}∩{x: Cx=c}. It is easy to see that U⊆V. Assume ƒ(x*)=ƒ(x*(N)), but x*≠x*(N). Note that x*, x*(N)∉V. Since V is convex, consider a line joining x*and x*(N). For any point λₜ=tx*+(1−t)x*(N),

ƒ(λₜ)≤tƒ(x*)+(1−t)ƒ(x*(N))=ƒ(x*(N)).

Thus, ƒ is constant on the line joining x*and x*(N). But, it is known that ƒ is strongly convex since A is positive definite. Thus, there exists only one unique minimum. Hence, a contradiction, which proves x*=x*(N). Now assume that ƒ(x*)≥ƒ(x*(N)). Clearly, x*(N)∉U. Suppose x*∈Ů, the interior of U. Let \tilde{x}∈∂U denote the point on the line joining x*and x*(N). Thus, \tilde{x}=tx*+(1−t)x*(N) for some t>0. Thus, ƒ(\tilde{x})<tƒ(x*)+(1−t)ƒ(x*(N))≤ƒ(x*). But x*is the minimizer over U. Thus, there is a contradiction, which gives x*∈∂U. This completes the proof.

Lemma 4. following the notation of Lemma 3, if x*(N)∉U, then x*lies on ∂U within the conic cap of U generated from x*(N).

Proof. Since the gradient of f is linear, the result follows from a similar argument to Lemma 3.

Based on the above two results the function, g, can be identified, such as by considering the maximum distance of the point lying on the intersection of the cone and S. This is highly dependent on the shape of S and on the cover T_{N}. Explicit calculation can give us explicit rates of convergence.

A comparison to the current state-of-the-art solvers of QCQP is provided. Specifically, the low-discrepancy techniques described are compared to the SDP and RLT relaxation procedures. For small enough problems, embodiments are compares to the exact solution by interior point methods. Furthermore, empirical evidence is provided to show that the low discrepancy sampling techniques are better than other simpler sampling procedures such as uniform sampling on the unit square or on the unit sphere and then mapping it subsequently to a decision space domain as described. Consider a very simple QCQP for the form

$${Minimize}_{x} {x}^{T} Ax$$

$$subject to {( x - {x}_{0} )}^{T} B ( x - {x}_{0} ) \leq \tilde{b} , \\ 1 \leq x \leq u .$$

A, B, x₀ and \tilde{b} are randomly sampled. The lower bound, l, and upper bound, u, are chosen in a way such that they intersect the ellipsoid. The dimension, n, of the problem is varied and the final objective value is tabulated as well as the time taken for the different procedures to converge. Results are presented in Table 1. Throughout the simulations, η=2, and the number of optimal points as N=max(1024, 2^{m}), where m is the smallest integer such that 2^{m}≤10n. Note that even though the SDP and the interior point methods converge very efficiently for small values of n, they cannot scale to values of n≥1000, which is where the strength of embodiments becomes more evident. From Table 1 it is observed that the relaxation procedures SDP and RLT fail to converge within an hour of computation time for n≥1000, whereas all the approximation procedures can easily scale up to n=106 variables. The exact solution is obtained by solving the problem using cvx in MATLAB. SDP performs slightly better than RLT for higher dimensions.

Furthermore, embodiments give the best approximation result when compared to the remaining two sampling schemes. Lemma 3 shows that if the both the objective values are the same the exact solution is attained. To see how much the approximation deviates from the truth, the relative error is tabulated.

TABLE 1
The Optimal Objective Value and Convergence Time

| | Low | | | | | | | | | | | |
|---|---|---|---|---|---|---|---|---|---|---|---|---|
| | discrepancy | | Sampling | | Sampling | | | | | | | |
| n | estimation | | [0, 1]ⁿ | | on Sⁿ | | SDP | | RLT | | Exact | |
| 5 | 3.00 | (4.61 s) | 2.99 | (4.74 s) | 2.95 | (6.11 s) | 3.07 | (0.52 s) | 3.08 | (0.51 s) | 3.07 | (0.49) |
| 10 | 206.85 | (5.04 s) | 205.21 | (5.65 s) | 206.5 | (5.26 s) | 252.88 | (0.53 s) | 252.88 | (0.51 s) | 252.88 | (0.51) |
| 20 | 6291.4 | (6.56 s) | 4507.8 | (6.28 s) | 5052.2 | (6.69 s) | 6841.6 | (2.05 s) | 6841.6 | (1.86 s) | 6841.6 | (0.54) |
| 50 | 99668 | (15.55 s) | 15122 | (18.98 s) | 26239 | (17.32 s) | 1.11 × 10⁵ | (4.31 s) | 1.08 × 10⁵ | (2.96 s) | 1.11 × 10⁵ | (0.64) |
| 100 | 1.40 × 10⁶ | (58.41 s) | 69746 | (1.03 m) | 1.24 × 10⁶ | (54.69 s) | 1.62 × 10⁶ | (30.41 s) | 1.52 × 10⁶ | (15.36 s) | 1.62 × 10⁶ | (2.30 s) |

| | | | | | | | | | |
|---|---|---|---|---|---|---|---|---|---|
| 1000 | 2.24 × 10⁷ | (14.87 m) | 8.34 × 10⁶ | (15.63 m) | 9.02 × 10⁶ | (15.32 m) | NA | NA | NA |
| 10⁵ | 3.10 × 10⁸ | (25.82 m) | 7.12 × 10⁷ | (24.59 m) | 8.39 × 10⁷ | (27.23 m) | NA | NA | NA |
| 10⁶ | 3.91 × 10⁹ | (38.30 m) | 2.69 × 10⁸ | (39.15 m) | 7.53 × 10⁸ | (37.21 m) | NA | NA | NA |

TABLE 2
The Relative Error: ∥x*(N) − x*∥/∥x*∥

| | Low | | |
|---|---|---|---|
| | discrepancy | Sampling | Sampling on |
| N | estimation | on [0, 1]ⁿ | Sⁿ |
| 5 | 0.0615 | 0.0828 | 0.0897 |
| 10 | 0.0714 | 0.1530 | 0.1229 |
| 20 | 0.0895 | 0.2455 | 0.2368 |
| 50 | 0.3352 | 3.8189 | 1.0472 |
| 100 | 0.8768 | 13.3709 | 2.0849 |

The relative error is ∥x*(N)−x*∥/∥x*∥ for each of the sampling procedures in Table 2. SDP and RLT results are omitted in Table 2 since both produce a solution very close to the exact minimum for small n. From the results in Table 2 it is clear that embodiments get the smallest relative error compared to the other sampling schemes.

Discussed herein are systems, devices, and methods for solving a large scale QCQP problem by relaxing the quadratic constraint by a near-optimal sampling scheme. This approximate method can scale up to very large problem sizes (up to 1000× larger than the current known QCQP solvers), while generating solutions which have good theoretical properties of convergence.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover all adaptations or variations of various embodiments. Combinations of the above embodiments, and other embodiments not specifically described herein, will be apparent to those of skill in the art upon reviewing the above description.

1. A computer system, comprising:
a processor;
a memory device holding an instruction set executable on the processor to cause the computer system to perform operations comprising:
determining a decision space representing a set of content items to be presented on a user interface of a social networking site, the decision space accounting for competing quadratic constraints and interaction effects;
estimating the decision space to linearize the competing quadratic constraints;
determining, in the estimated decision space and using an objective function, a display probability for each content item in the set of content items, each respective display probability corresponding to a given content item's probability of display in a specific content slot of a plurality of content slots on the user interface; and
causing display of the content items with the highest determined display probabilities on the user interface.

2. The computer system of claim 1, wherein estimating the decision space includes selecting points on an outer surface of the decision space.

3. The computer system of claim 2, wherein selecting the points on the outer surface of the decision space includes selecting points that minimize Riesz energy.

4. The computer system of claim 3, wherein estimating the decision space includes mapping the selected points to a hypersphere and then mapping the points mapped to the hypersphere to the decision space.

5. The computer system of claim 4, wherein estimating the decision space includes determining a linear bounded cover of planes tangent to the decision space to create the estimated decision space, each of the planes tangent to the decision space including a point of the selected points mapped to the decision space.

6. The computer system of claim 5, wherein the selected points are equidistributed.

7. The computer system of claim 1, further comprising:
generating the set of interaction effects, each interaction effect defined for a specific pair of content items concurrently displayed at a specific pair of content slots on the user interface, each interaction effect representative of social network activity that occurred due to display of a corresponding pair of content items to various member accounts.

8. A computer-implemented method comprising:
determining a decision space representing a set of content items to be presented on a user interface of a social networking site, the decision space accounting for competing quadratic constraints and interaction effects;
estimating the decision space to linearize the competing quadratic constraints;
determining, in the estimated decision space and using an objective function, a display probability for each content item in the set of content items, each respective display probability corresponding to a given content item's probability of display in a specific content slot of a plurality of content slots on the user interface; and
causing display of the content items with the highest display probabilities.

9. The computer-implemented method of claim 8, wherein estimating the decision space includes selecting points on an outer surface of the decision space.

10. The computer-implemented method of claim 9, wherein selecting the points on the outer surface of the decision space includes selecting points that minimize Riesz energy.

11. The computer-implemented method of claim 10, wherein estimating the decision space includes mapping the selected points to a hypersphere and then mapping the points mapped to the hypersphere to the decision space.

12. The computer-implemented method of claim 11, wherein estimating the decision space includes determining a linear bounded cover of planes tangent to the decision space to create the estimated decision space, each of the planes tangent to the decision space including a point of the selected points mapped to the decision space.

13. The computer-implemented method of claim 12, wherein the selected points are equidistributed.

14. The computer-implemented method of claim 13, further comprising:
generating the set of interaction effects, each interaction effect defined for a specific pair of content items concurrently displayed at a specific pair of content slots in a given social network feed, each interaction effect representative of social network activity that occurred due to display of a corresponding pair of content items to various member accounts.

15. A non-transitory computer-readable medium storing executable instructions thereon, which, when executed by a processor, cause the processor to perform operations including:
determining a decision space representing a set of content items to be presented on a user interface of a social networking site, the decision space accounting for competing quadratic constraints and interaction effects;
estimating the decision space to linearize the competing quadratic constraints;
determining, in the estimated decision space and using an objective function, a display probability for each content item in the set of content items, each respective display probability corresponding to a given content item's probability of display in a specific content slot of a plurality of content slots on the user interface; and
causing display of the content items with the highest display probabilities.

16. The non-transitory computer-readable medium of claim 15, wherein estimating the decision space includes selecting points on an outer surface of the decision space.

17. The non-transitory computer-readable medium of claim 16, wherein selecting the points on the outer surface of the decision space includes selecting points that minimize Riesz energy.

18. The non-transitory computer-readable medium of claim 17, wherein estimating the decision space includes mapping the selected points to a hypersphere and then mapping the points mapped to the hypersphere to the decision space.

19. The non-transitory computer-readable medium of claim 18, wherein estimating the decision space includes determining a linear bounded cover of planes tangent to the decision space to create the estimated decision space, each of the planes tangent to the decision space including a point of the selected points mapped to the decision space.

20. The non-transitory computer-readable medium of claim 19, wherein the selected points are equidistributed.
